(19) United States
(12) Patent Application Publication
(10) Pub. No.: US 2012/0219761 A1
(43) Pub. Date: Aug. 30, 2012

(54) TRIMMER LINE

(76) Inventors: Arnaud Legrand, Wooster, OH (US); Emmanuel Legrand, Villefranche (FR)

(21) Appl. No.: 13/334,714

(22) Filed: Dec. 22, 2011

Related U.S. Application Data
(60) Provisional application No. 61/426,073, filed on Dec. 22, 2010.

(51) Int. Cl. A01D 34/416; B32B 3/06; B23P 11/02

(52) U.S. Cl. 428/162; 29/453

(57) ABSTRACT

A trimmer line may have a protrusion that is receivable in a recess to maintain the trimmer line in a coiled condition without packaging.

### CROSS-REFERENCE TO RELATED APPLICATIONS

This application claims the benefit of U.S. Provisional Application No. 61/426,073, titled TRIMMER LINE, filed Dec. 22, 2010, which is herein incorporated by reference.

### I. BACKGROUND

A. Field of Invention

This invention generally relates to methods and apparatuses concerning trimmer lines and more specifically relates to methods and apparatuses concerning a trimmer line having a protrusion and a recess where the protrusion is receivable in the recess to maintain the trimmer line in a coiled condition without packaging.

B. Description of the Related Art

It is well known to use various types and styles of a device, commonly referred to as a trimmer, to cut weeds, grass and other such vegetation. While some trimmers use rigid rotating steel blades to contact and cut the vegetation, it is also known to rotate flexible cords or lines, commonly referred to as trimmer lines. Typically short lengths of the trimmer line are propelled (usually rotated) by the trimmer to cut the vegetation. Trimmer lines are formed of various materials including nylon, copolymer nylon and other plastics.

While known trimmer lines generally work well for their intended purposes, they have a problem. FIG. 9 shows a known trimmer line 1 that is wound around a spool 2. The trimmer line 1 is coiled onto the spool 2 in a known manner (to store the trimmer line) and the spool 2 with the trimmer line 1 coiled around it is then transported in a known manner. The problem. shown in FIG. 9, is that the trimmer line 1 does not remain coiled to the spool 2 but instead unravels and comes off of the spool 2. FIG. 10 illustrates the same problem as a trimmer line 3 does not remain coiled within housing 4 but again unravels.

In order to overcome the unraveling problem shown in FIGS. 9 and 10, it is known to apply packaging material (not shown) such as plastic wraps over the spool 2 or within the housing 4 to maintain the trimmer line 1, 3 in a coiled condition. Packaging material adds undesirable cost and complexity to the storage and transportation of trimmer lines.

What is needed is a way to maintain a trimmer line in a coiled condition without the use of packaging.

### II. SUMMARY

According to one embodiment of this invention, an apparatus may comprise a trimmer line that is severable into sections that are suitable for use with an associated trimmer device to be propelled against associated vegetation to cut the associated vegetation. A first protrusion formed on a first portion of the trimmer line may be receivable in a first recess formed on a second portion of the trimmer line to maintain the trimmer line in a coiled condition without packaging. The first protrusion may be removable from the first recess to uncoil the trimmer line.

According to another embodiment of this invention, an apparatus may comprise: a hanger comprising: an attachment surface by which the hanger can be attached to an associated structure; and, a trimmer line reception surface; and, a trimmer line that is severable into sections that are suitable for use with an associated trimmer device to be propelled against associated vegetation to cut the associated vegetation. A first protrusion formed on a first portion of the trimmer line may be receivable in a first recess formed on a second portion of the trimmer line to maintain the trimmer line in a coiled condition around the trimmer line reception surface without packaging. The reception of the first protrusion within the first recess may create a snap fit connection and the first protrusion may removable from the first recess to uncoil the trimmer line.

According to yet another embodiment of this invention, a method may comprise the steps of: (A) providing a trimmer line that: (1) is severable into sections that are suitable for use with an associated trimmer device to be propelled against associated vegetation to cut the associated vegetation; and, (2) comprises a first protrusion formed on a first portion of the trimmer line and a first recess formed on a second portion of the trimmer line; (B) coiling the trimmer line; and, (C) positioning the first protrusion into the first recess to maintain the trimmer line in a coiled condition without packaging.

One advantage of this invention is that a trimmer line can be easily maintained in a coiled condition without packaging.

Another advantage of this invention is that a length of trimmer line can be used and then the remaining trimmer line can easily be returned to a coiled condition.

Other benefits and advantages of the invention will become apparent to those skilled in the art to which it pertains upon a reading and understanding of the following detailed specification.

### III. BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 is a perspective view of a trimmer device.

FIG. 2 is a perspective view of a coil of trimmer line.

FIG. 3 is a perspective end view of an embodiment of trimmer line.

FIG. 4 is a perspective end view of another embodiment of trimmer line.

FIG. 5 is a perspective end view of yet another embodiment of trimmer line.

FIG. 6 is a perspective view of a spool.

FIG. 7 is a perspective view of a hanger.

FIG. 8 is a side view of trimmer line coiled around the hanger of FIG. 7.

FIG. 9 is a perspective view of a prior art trimmer line coiled around a spool.

FIG. 10 is a perspective view of a prior art trimmer line coiled within a housing.

### IV. DETAILED DESCRIPTION

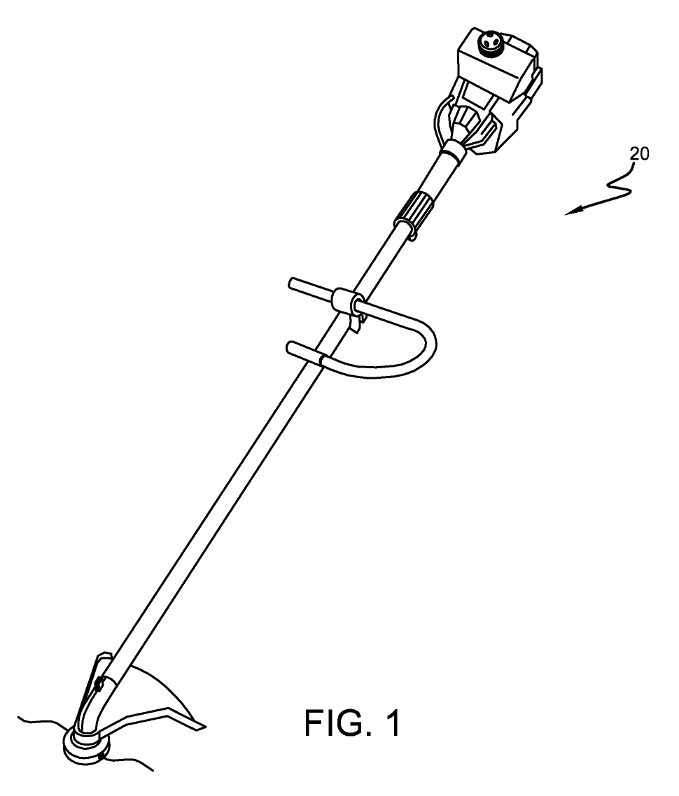

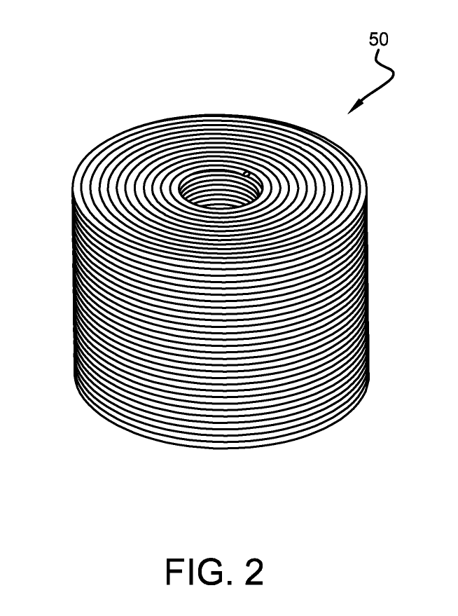

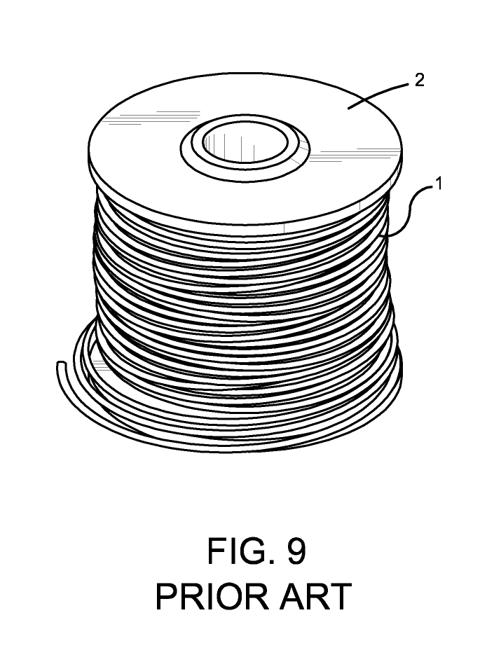

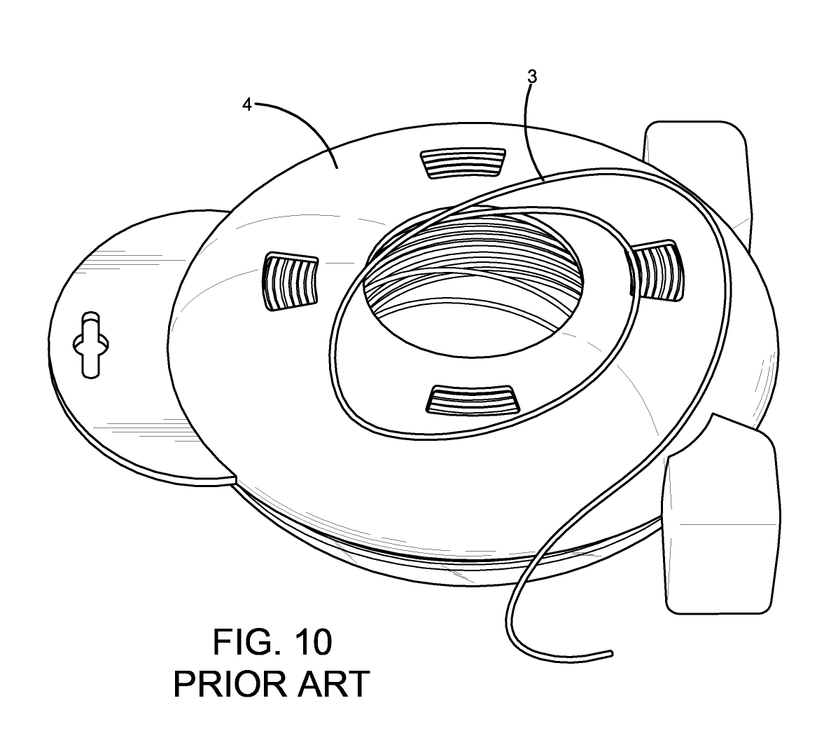

Referring now to the drawings wherein the showings are for purposes of illustrating embodiments of the invention only and not for purposes of limiting the same, and wherein like reference numerals are understood to refer to like components, FIG. 1 shows a trimmer device 20 that may use trimmer line 50, shown in FIG. 2, according to this invention. The trimmer device 20 can be of any size and type chosen with the sound judgment of a person of skill in the art. The trimmer line 50 can also be of any length, size and material chosen with the sound judgment of a person of skill in the art. The trimmer line 50 may be severable into sections that are then attached to the trimmer device 20 in a known manner. The trimmer device 20 may then be used to propel the section against grass, weeds or other vegetation (not shown) to cut the vegetation. As the operation of trimmer devices and trimmer lines are well known to those of skill in the art, further details will not be provided here except as provided below. FIG. 2 shows the trimmer line 50 of this invention in a coiled condition and maintained in the coiled condition without any packaging required. (This is in contrast to the prior art, shown for example in FIGS. 9 and 10, where coiled trimmer lines unravel from their coiled condition unless packaging is applied to them.

With reference now to FIGS. 3-5, to maintain the trimmer line 50 in the coiled condition, a protrusion 52 is formed on a first portion of the trimmer line 50 and a recess 56 is formed on a second portion of the trimmer line 50. The protrusion 52 is then inserted into (received within) the recess 56 and thus the trimmer line 50 is maintained in the coiled condition. To uncoil the trimmer line 50, such as when it is desirable to use the trimmer line 50, it is only necessary to remove the protrusion 52 from the recess 56.

With continuing reference to FIGS. 3-5, the number, style and shape of the protrusion(s) and corresponding recess(es) can be any chosen with the sound judgment of a person of skill in the art. In one embodiment, shown, both the protrusion 52 and the recess 56 extend along the entire length of the trimmer line 50. Such extending protrusions 52 and recesses 56 may be formed into the trimmer line 50 in any manner chosen with the sound judgment of a person of skill in the art. In one embodiment, they are formed in an extrusion process.

Still referring to FIGS. 3-5, in one embodiment the reception of the protrusion 52 within the recess 56 creates a snap fit connection. By “snap fit” it is meant a mechanical connection where the protrusion 52 is constrained or locked within the recess 56 by a constraint feature that is homogeneous with the trimmer line 50. To insert the protrusion 52 into the recess 56 (to thereby join, attach or connect the protrusion 52 to the recess 56) it is necessary to move the constraint feature. After the constraint feature has been moved, it returns fully (or partially) to its initial position to maintain the attachment. To remove the protrusion 52 from the recess 56 (to thereby disjoin, detach or disconnect the protrusion 52 from the recess 56) it is again necessary to move the constraint feature. And as before, after the constraint feature has been moved, it returns fully (or partially) to its initial position. The constraint feature 60 used with a snap fit connection in this invention can be any chosen with the sound judgment of a person of skill in the art. For the embodiments shown, the constraint feature 60 comprises a pair of edges 62, 62 formed on an outer surface of the trimmer line 50 juxtaposed to the recess 56. This gives the recess 56 a minimum width WR that is smaller than the maximum width WP of the protrusion 52. As the operation of a snap fit is well known to those of skill in the art, further details will not be provided here.

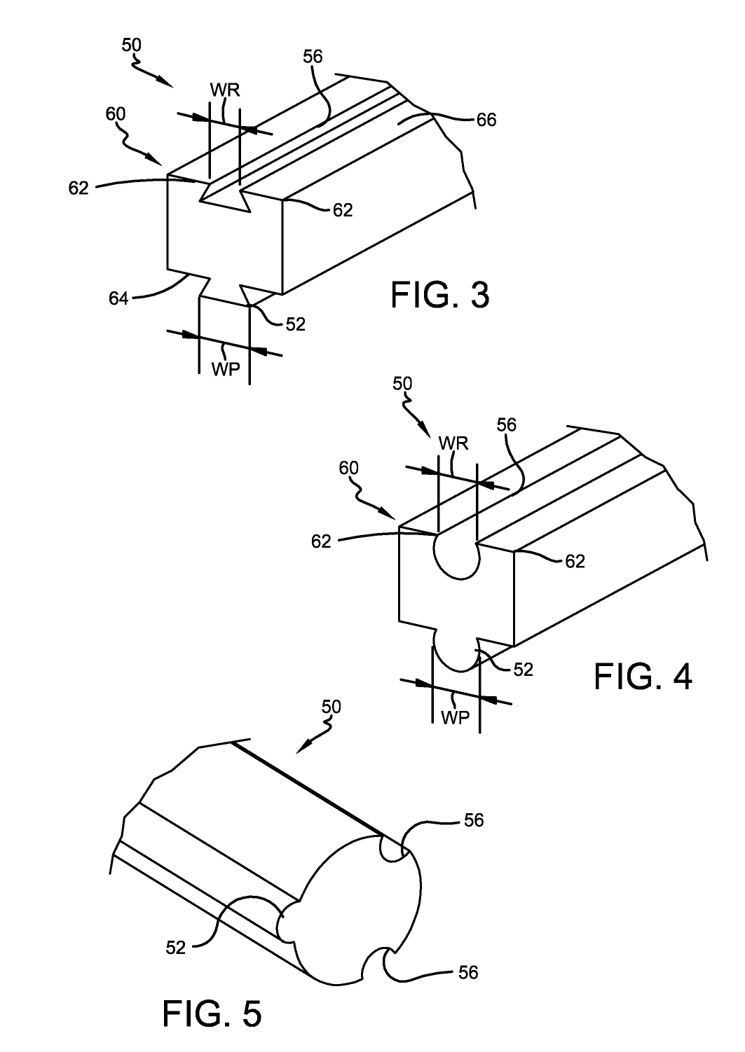

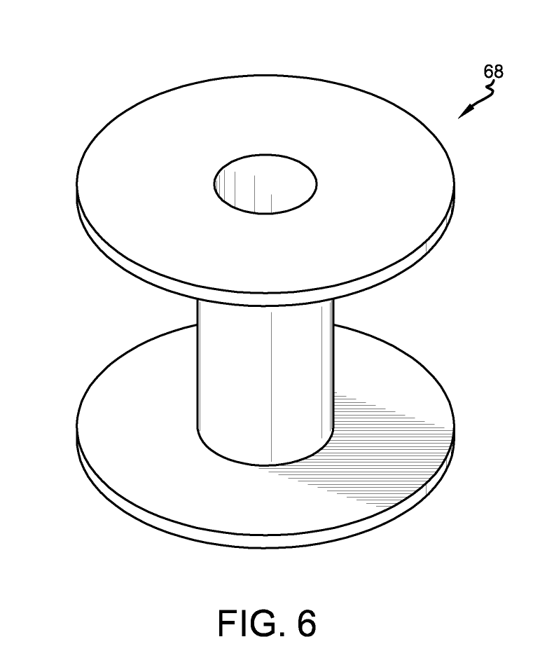

In one embodiment, shown in FIGS. 3 and 4, the trimmer line 50 has a rectangular. cross-sectional shape. In another embodiment, shown in FIG. 5, the trimmer line 50 has a circular cross-sectional shape. Other shapes are also possible with this invention. In FIG. 3 the protrusion 54 extends from a first side 64 of the trimmer line 50 and the recess 56 indents from a second side 66 of the trimmer line 50 that is opposite of the first side 64. Other arrangements are also possible with this invention. FIG. 5 shows an embodiment where two recesses 56, 56 are used but only one protrusion 52 is provided. The protrusion 52 may be received in either of the recesses 56, 56. These examples are non-limiting as various numbers of protrusions 52 and recesses 56 may be used as desired. When multiple protrusions 52 and recesses 56 are used, it is contemplated in one embodiment to permit all the protrusions 52 to be receivable within all the recesses 56. In another embodiment, it is contemplated to permit only some of the protrusions 52 to be receivable only within some recesses 56 while other protrusions 52 are receivable only within other recesses 56.

FIG. 3 shows an embodiment where the protrusion 52 and the recess 56 have a trapezoidal cross-sectional shape. Here by “trapezoidal” it is meant a quadrilateral having only one pair of parallel sides. FIGS. 4 and 5 show an embodiment where the protrusion 52 and the recess 56 have semi-circular cross-sectional shapes. These are non-limiting examples as various shapes of protrusions 52 and recesses 56 may be used as desired.

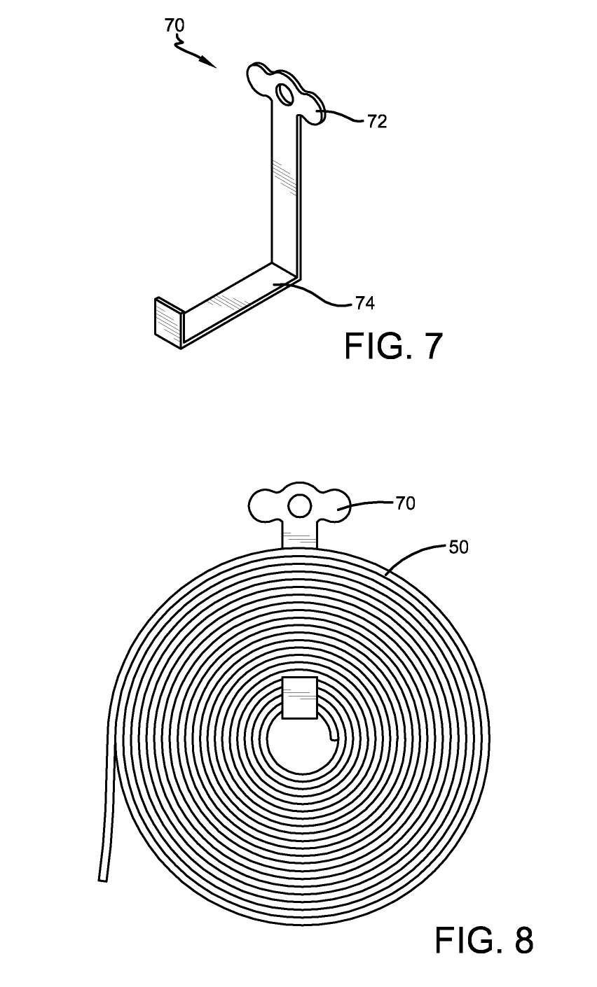

The trimmer line 50 can be coiled alone or with any other component chosen with the sound judgment of a person of skill in the art. FIG. 2 shows one embodiment where the trimmer line 50 is coiled without any other component—thus, it is “stand alone.” FIG. 6 shows a spool 68 about which the trimmer line 50 can be coiled in another embodiment. In yet another embodiment, shown in FIGS. 7 and 8, a hanger 70 may be used with the trimmer line 50. The hanger 70 may include an attachment surface 72 by which the hanger 70 can be attached to an associated structure (not shown) in any known manner. The hanger 70 may also include a trimmer line reception surface 74 about which the trimmer line 50 may be coiled. FIG. 8 shows the trimmer line 50 coiled to the hanger 70.

Use of the trimmer line 50 will now be described. Once the trimmer line 50 has been manufactured, it is coiled. It may be coiled as a stand alone component (FIG. 2) or it may be coiled around a spool 68 (FIG. 6) a hanger 70 (FIGS. 7 and 8) or another component. Once the coiling is nearly complete, a protrusion 52 on the distal end of the trimmer line 50 is inserted within a recess 56 on the trimmer line 50 that is coiled. This maintains the trimmer line 50 in a coiled condition without packaging. The coil of trimmer line 50 can then be transported to a desired destination. To use a portion of the trimmer line 50, the protrusion 52 is first removed from the recess 56. This permits as much of the trimmer line 50 to be uncoiled as desired. The trimmer line 50 may then be cut to any desired length for use as is well known. The distal end of the remaining trimmer line 50 may be attached to the unused coil by once again inserting a protrusion 52 on the remaining distal end within a recess 56 on the trimmer line 50 that is coiled. As before, this maintains the trimmer line 50 in a coiled condition without packaging.

Numerous embodiments have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

Having thus described the invention, it is now claimed:

I/We claim:

1. An apparatus comprising:
a trimmer line that is severable into sections that are suitable for use with an associated trimmer device to be propelled against associated vegetation to cut the associated vegetation;
wherein a first protrusion formed on a first portion of the trimmer line is receivable in a first recess formed on a second portion of the trimmer line to maintain the trimmer line in a coiled condition without packaging; and,
wherein the first protrusion is removable from the first recess to uncoil the trimmer line.

2. The apparatus of claim 1 wherein the first protrusion and first recess extend along the entire length of the trimmer line.

3. The apparatus of claim 1 wherein the reception of the first protrusion within the first recess creates a snap fit connection.

4. The apparatus of claim 1 further comprising:
a spool about which the trimmer line is coiled.

5. The apparatus of claim 1 wherein the trimmer line further comprises:
a second protrusion formed on the first portion of the trimmer line;
a second recess formed on the second portion of the trimmer line;
wherein the second protrusion is receivable in the second recess to maintain the trimmer line in a coiled condition without packaging;
wherein the first protrusion is receivable in the second recess to maintain the trimmer line in a coiled condition without packaging; and,
wherein the second protrusion is receivable in the first recess to maintain the trimmer line in a coiled condition without packaging.

6. The apparatus of claim 1 wherein:
the trimmer line has a substantially rectangular cross-sectional shape;
the first protrusion extends from a first side of the trimmer line; and,
the first recess indents from a second side of the trimmer line that is opposite the first side of the trimmer line.

7. The apparatus of claim 1 wherein:
the first protrusion has a trapezoidal cross-sectional shape; and,
the first recess has a trapezoidal cross-sectional shape.

8. The apparatus of claim 1 wherein:
the first protrusion has a semi-circular cross-sectional shape; and,
the first recess has a semi-circular cross-sectional shape.

9. The apparatus of claim 4 wherein:
the first protrusion and first recess extend along the entire length of the trimmer line;
the reception of the first protrusion within the first recess creates a snap fit connection;
the trimmer line has a substantially rectangular cross-sectional shape;
the first protrusion extends from a first side of the trimmer line; and,
the first recess indents from a second side of the trimmer line that is opposite the first side of the trimmer line.

10. An apparatus comprising:
a hanger comprising: an attachment surface by which the hanger can be attached to an associated structure; and, a trimmer line reception surface;
a trimmer line that is severable into sections that are suitable for use with an associated trimmer device to be propelled against associated vegetation to cut the associated vegetation;
wherein a first protrusion formed on a first portion of the trimmer line is receivable in a first recess formed on a second portion of the trimmer line to maintain the trimmer line in a coiled condition around the trimmer line reception surface without packaging;
wherein the reception of the first protrusion within the first recess creates a snap fit connection; and,
wherein the first protrusion is removable from the first recess to uncoil the trimmer line.

11. The apparatus of claim 10 wherein:
the first protrusion and first recess extend along the entire length of the trimmer line;
the first protrusion has a trapezoidal cross-sectional shape; and,
the first recess has a trapezoidal cross-sectional shape.

12. A method comprising the steps of:
(A) providing a trimmer line that: (1) is severable into sections that are suitable for use with an associated trimmer device to be propelled against associated vegetation to cut the associated vegetation; and, (2) comprises a first protrusion formed on a first portion of the trimmer line and a first recess formed on a second portion of the trimmer line;
(B) coiling the trimmer line; and,
(C) positioning the first protrusion into the first recess to maintain the trimmer line in a coiled condition without packaging.

13. The method of claim 12 wherein:
step (C) comprises the step of: snap fitting the first protrusion into the first recess.

14. The method of claim 12 wherein:
step(B) comprises the step of: coiling the trimmer line around a spool.

15. The method of claim 12 wherein:
the method further comprises the step of: providing a hanger comprising: an attachment surface by which the hanger can be attached to an associated structure; and, a trimmer line reception surface; and,
step (B) comprises the step of: coiling the trimmer line around the trimmer line reception surface.

16. The method of claim 12 wherein:
step (A) comprises the step of: providing the first protrusion and the first recess to extend along the entire length of the trimmer line.

17. The method of claim 12 wherein:
step (A) comprises the steps of: providing the trimmer line with a substantially rectangular cross-sectional shape; providing the first protrusion to extend from a first side of the trimmer line; and, providing the first recess to indent from a second side of the trimmer line that is opposite the first side of the trimmer line.

18. The method of claim 12 wherein:
step (A) comprises the steps of: providing the trimmer line with a second protrusion formed on the first portion of the trimmer line; providing the trimmer line with a second recess formed on the second portion of the trimmer line; providing the second protrusion to be receivable in the second recess to maintain the trimmer line in a coiled condition without packaging; providing the first protrusion to be receivable in the second recess to maintain the trimmer line in a coiled condition without packaging; and, providing the second protrusion to be receivable in the first recess to maintain the trimmer line in a coiled condition without packaging.

19. The method of claim 16 wherein:
step (A) comprises the steps of: providing the trimmer line with a substantially rectangular cross-sectional shape; providing the first protrusion to extend from a first side of the trimmer line; and, providing the first recess to indent from a second side of the trimmer line that is opposite the first side of the trimmer line;
step (B) comprises the step of: coiling the trimmer line around a spool;
step (C) comprises the step of: snap fitting the first protrusion into the first recess; and,
the method further comprises the step of: removing the first protrusion from the first recess to uncoil the trimmer line.

20. The method of claim 16 wherein:
the method further comprises the step of: providing a hanger comprising: an attachment surface by which the hanger can be attached to an associated structure; and, a trimmer line reception surface;
step (A) comprises the step of: providing the first protrusion and the first recess to extend along the entire length of the trimmer line;
step (B) comprises the step of: coiling the trimmer line around the trimmer line reception surface; and,
step (C) comprises the step of: snap fitting the first protrusion into the first recess.
